(19) United States
(12) Patent Application Publication
(10) Pub. No.: US 2020/0110981 A1
(43) Pub. Date: Apr. 9, 2020

(54) Hybrid Deep-Learning Action Prediction Architecture

(71) Applicant: Adobe Inc., San Jose, CA (US)

(72) Inventors: Zhenyu Yan, Cupertino, CA (US); Jun He, Fremont, CA (US); Fei Tan, Harrison, NJ (US); Xiang Wu, Mountain View, CA (US); Bo Peng, Santa Clara, CA (US); Abhishek Pani, San Francisco, CA (US)

(73) Assignee: Adobe Inc., San Jose, CA (US)

(21) Appl. No.: 16/152,227

(22) Filed: Oct. 4, 2018

(51) Int. Cl. G06N 3/04; G06N 3/08

(52) U.S. Cl. CPC G06N 3/0454; G06N 3/0445; G06N 3/049; G06N 3/08; G06N 3/04

(57) ABSTRACT

A hybrid deep-learning action prediction architecture system is described that predicts actions. The architecture includes a main path and an auxiliary path. The main path may contain multiple layers of convolutional neural networks for further aggregation to coarser time spans. The resultant data produced by the convolutional neural networks is passed to multiple layers of LSTMs. The outputs from LSTMs are then combined with the profile in the auxiliary path to predict an action label.

### BACKGROUND

Digital analytics systems are implemented to analyze “big data” (e.g., Petabytes of data) to gain insights that are not possible to obtain, solely, by human users. In one such example, digital analytics systems are configured to analyze big data to predict occurrence of future actions, which may support a wide variety of functionality. Prediction of future action, for instance, may be used to determine when a machine failure is likely to occur, improve operational efficiency of devices to address occurrences of events (e.g., to address spikes in resource usage), resource allocation, and so forth.

In other examples, this may be used to predict user actions. Accurate prediction of user actions may be used to manage provision of digital content and resource allocation by service provider systems and thus improve operation of devices and systems that leverage these predictions. Examples of techniques that leverage prediction of user interactions include recommendation systems, digital marketing systems (e.g., to cause conversion of a good or service), systems that rely on a user propensity to purchase or cancel a contract relating to a subscription, likelihood of downloading an application, signing up for an email, and so forth. Thus, prediction of future actions may be used by a wide variety of service provider systems for personalization, customer relation/success management (CRM/CSM), and so forth for a variety of different entities, e.g., devices and/or users.

Techniques used by conventional digital analytics systems to predict occurrence of future actions, however, are faced with numerous challenges that limit accuracy of the predictions as well as involve inefficient use of computational resources. One challenge service provider systems face is customer churn, i.e., loss of customers. In operation, the service provider system may take measures to mitigate customer churn, which are called customer retention measures. Customer retention measures implemented by the service provider systems primarily involve targeting customers at a high churn risk with a churn prediction model. A churn prediction model is then used by the digital analytics system to determine proactive measures to engage with customers to reduce a risk of churn.

Conventional techniques involving a churn prediction model used to predict user actions formulate the problem as binary classification, e.g., by trying to predict whether the action has or has not occurred. This technique, as implemented by conventional digital analytics systems uses a feature set for modeling user behavior that includes user profile features and behavior features. User profile features typically include characteristics and properties of users. The behavior features include properties and characteristics of behaviors that a user may exhibit. Behavior features, in conventional digital analytics systems, are typically hand-crafted or manually developed. And, while such conventional formulations can, in some instances, be effective to some degree, there are drawbacks and challenges that cause inaccuracy in the prediction and use of computational resources.

In one such example, a technical challenge faced by conventional digital analytics systems involves how to obtain an optimal feature set based on handcrafted features and how best to automate feature generation. That is, handcrafted features can fail to take into account the technical complexity of the landscape and can thus result in a less than desirable feature set (i.e., is not “optimal”) due to the limited knowledge of a user that manually inputs the handcrafted features. Although convention techniques have been developed to automate feature generation, these conventional techniques are generally slow to train (and thus do not support real time operation) and fail to achieve desirable results flowing from an inability to preserve an adequate amount of information.

Another technical challenge involves how best to increase data utilization by taking multiple historical outcomes for every customer. That is, the “binary classification” approach of conventional methods does not utilize data at a level of granularity in a manner that supports robust and accurate prediction outcomes for every customer. As a result of these challenges, conventional digital analytics systems fail to accurately predict actions and involve inefficient use of computational resources.

### SUMMARY

To address the above-identified challenges, a deep learning architecture is utilized by a digital analytics system for action prediction, e.g., user or machine actions. The deep learning architecture implements a model that dramatically outperforms conventional models and provides useful insights into those actions, thereby increasing accuracy of the predictions and operational efficiency of computing devices that implement the model.

In one or more implementations, a hybrid deep-learning based, multi-path architecture is employed by a digital analytics system for action prediction. In one example, the architecture includes main and auxiliary paths. The main path includes one or more convolutional neural networks (ConvNets or CNN), long-short-term-memory (LSTM) neural networks and time distributed dense networks. These networks collectively process usage data and, from the auxiliary path, profile data, to produce an output in the form of a “label” which represents a predicted action that is predicted to happen in a next fixed time window at the end of a LSTM summary time span.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures may be indicative of one or more entities and thus reference may be made interchangeably to single or plural forms of the entities in the discussion.

FIG. 1 is an illustration of a digital medium environment in an example implementation that is operable to train and use a hybrid deep learning architecture described herein.

FIG. 2 is an illustration of a specific implementation of a hybrid deep learning architecture in accordance with one or more implementations.

FIG. 3 is a flow diagram that describes operations in accordance with one or implementations.

FIG. 4 illustrates an example specific architectural arrangement of the architecture of FIG. 2 in accordance with one implementation.

FIG. 5 illustrates charts that present performance comparisons between the innovative hybrid deep learning architecture and other baseline approaches.

FIG. 6 illustrates charts that present performance comparisons between the innovative hybrid deep learning architecture and a current production model.

FIG. 7 illustrates an example system including various components of an example device that can be implemented as any type of computing device as described and/or utilize with reference to FIGS. 1 and 2 to implement embodiments of the techniques described herein.

### DETAILED DESCRIPTION

Overview

Prediction of occurrence of future actions may be used to support a wide range of functionality by service provider systems as described above, examples of which include device management, control of digital content to users, and so forth. Conventional techniques and systems to do so, however, have limited accuracy due to the numerous challenges faced by these systems, including inaccuracies of handcrafted features and how to obtain an optimal feature set. Accordingly, service provider systems that employ these conventional techniques are confronted with inefficient use of computational resource to address these inaccuracies. For example, accuracy in prediction of events involving computational resource usage by a service provide system may result in outages in instances in which a spike in usage is not accurately predicted or over allocation of resources in instances in which a spike in usage is predicted but does not actually occur. Similar inefficiencies may be experienced in systems that relay on predicting events involving user actions, e.g., churn, upselling, conversion, and so forth.

Accordingly, a hybrid deep learning architecture system is described that overcomes the challenges of conventional systems to take proactive measures to optimize resource allocations. This includes supporting an ability of the hybrid deep learning architecture system for automatic feature generation such that handcrafted features are no longer required. Additionally, the hybrid deep learning feature architecture system supports inclusion of profile features through use of an auxiliary path that describes characteristics of an entity (e.g., user or device) that is associated with the action, which improves performance of the model in generating a prediction of the action.

In one example, the hybrid deep learning architecture includes a main path and the auxiliary path described above. The main path is implemented using modules of the hybrid deep learning architecture system to process input data including activity logs that describe activities and the like. User activities as reflected in activity logs can include, by way of example and not limitation, daily product usage summaries such as the daily application launch counts, daily total session time of all launches for each application and the like. The auxiliary path is also implemented using modules of the hybrid deep learning system to process profiles, which may include static profile features and dynamic profile features. Static profile features may refer to characteristics such as gender, geographical location, market segments, and the like that are time invariant. Dynamic profile features may refer to such things as software subscription age and the like that change over time. A connection architecture is then employed by the hybrid deep learning architecture system between the main and auxiliary paths. This enables the main path of the hybrid deep learning architecture system to consider both the static profile features and dynamic profile features to generate a prediction of an action, e.g., a user action, with increased accuracy. This is not possible using conventional systems and facilitates data utilization to provide multiple historical outcomes for each single user as further described below.

Furthermore, challenges posed with respect to how to deal with biased data sampling due to label definition are addressed by this architecture. The dual path architecture reduces biased data sampling, at least in part, by utilizing a convolutional neural network system to summarize aggregated user input, such as activity logs, and processing the summarized aggregated user input using a long short term memory (LSTM) neural network system. The long short term memory neural network system of the hybrid deep learning architecture system facilitates classification, processing, and predicting time series given time lags of unknown size and duration between events. A time distributed dense network system is then used to process the data produced by the long short term memory neural network, as well as static and dynamic profile data from the auxiliary path to provide more robust and accurate labels which constitute predicted user intended actions that are predicted to happen in a next fixed time window at the end of a LSTM summary time span.

In an implementation example, modules of the main path include one or more convolutional neural networks (ConvNets or CNN), long-short-term-memory (LSTM) neural networks and time distributed dense networks that collectively process user input usage data. The modules are also configured to process, from the auxiliary path, user profile data to produce an output in the form of a “label” which represents data describing a predicted action, e.g., “what is predicted to happen next” in a fixed time window.

In operation, the hybrid, deep-learning architecture system predicts actions using a unique model architecture having a main path and an auxiliary path. The main path contains multiple layers of ConvNets for further aggregation of blocks of usage summary vectors over time spans. The usage summary vectors are based on input data that describes actions over a time span having a first granularity. Aggregation of the blocks of usage summary vectors produces resultant data that summarizes the user actions over a time span that has a second granularity that is coarser than the first granularity. Aggregation of the blocks reduces noise and reduces training data size and thus improves efficiency in both training and use of the neural networks to generate predictions.

This resultant data is passed to multiple layers of Long Short Term Memory (LSTM) neural networks which determine long range interactions by capturing the long range interactions from the resultant data passed from the ConvNets. The prediction is then generated using multiple layers of a time distributed fully connected dense neural network based on the determined long range interactions with profile data supplied from the auxiliary path. The profile data, for instance, may describe static characteristics of an entity that corresponds to the action that do not change over time (e.g., market segments, gender) or dynamic characteristics of the entity that correspond to a particular time and/or do change over time (e.g., subscription age). As a result, accuracy of the prediction using the main path may be improved using profile data of the auxiliary path as further described below within this hybrid architecture.

In this way, the hybrid deep-learning architecture system for action prediction has several advantages over the traditional predictive models. Specifically, the innovative architecture is capable of automatic feature generation without the need for handcrafted features. Thus, the process is highly efficient, automatic, and easily scalable. The architecture also provides multiple outputs for one user at many recurrent layers, e.g., of LSTMs, for increased data utilization.

The machine-learning architecture described herein also has advantages over an LSTM-alone architecture. Specifically, the introduction of an auxiliary path enables inclusion of profile features which, in turn, improves model performance. The introduction of CNN into the hybrid deep learning architecture system transforms original summary time steps to coarser granularities which, in turn, reduces both noise and training time. Since CNNs can have a complex structure and the weights are learned through training, this way of aggregation is more automatic and can preserve more information than manual aggregation. The hybrid architecture is thus able to train faster and achieve better performance than LSTM-alone architectures, as will become apparent below.

In the following discussion, an example environment is first described that may employ the techniques described herein. Example procedures are also described which may be performed in the example environment as well as other environments. Consequently, performance of the example procedures is not limited to the example environment and the example environment is not limited to performance of the example procedures.

Example Environment

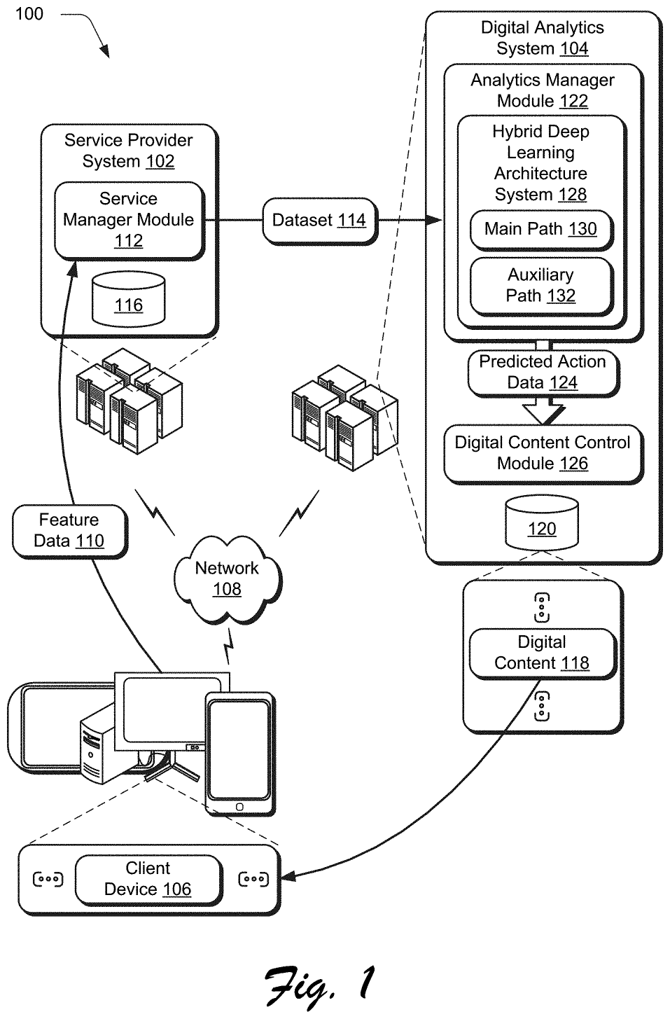

FIG. 1 is an illustration of a digital medium environment 100 in an example implementation that is operable to employ techniques for hybrid deep-learning for predicting user intended actions as described herein. The illustrated environment 100 includes a service provider system 102, a digital analytics system 104, and a plurality of client devices, an example of which is illustrated as client device 106. In this example, actions are described involving user actions performed through interaction with client devices 106. Other types of actions are also contemplated, including device actions (e.g., failure, resource usage), and so forth that are achieved without user interaction. These devices are communicatively coupled, one to another, via a network 108 and may be implemented by a computing device that may assume a wide variety of configurations.

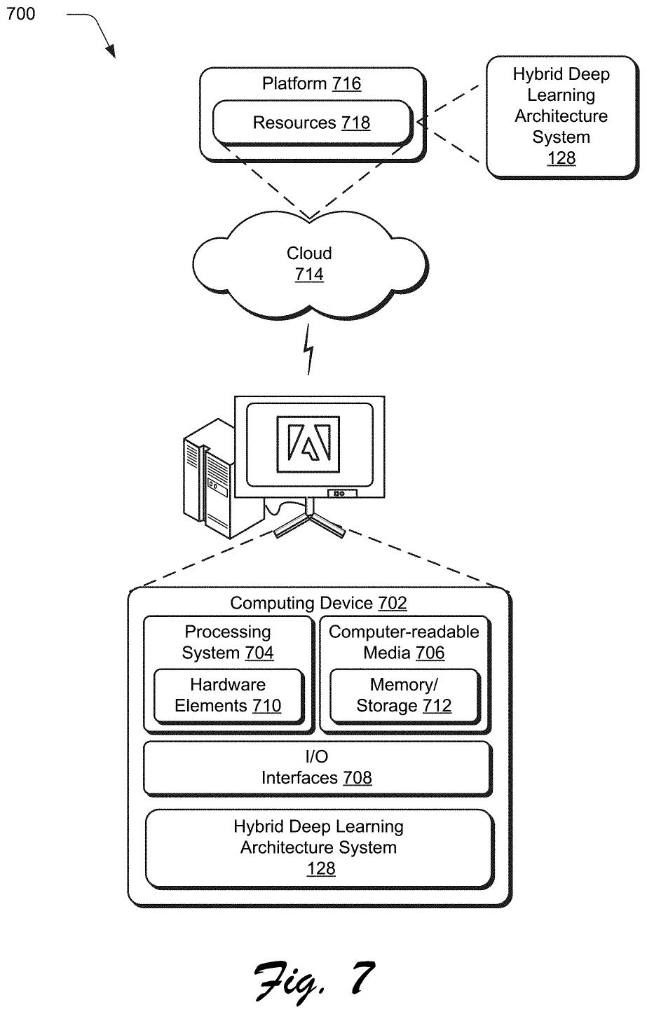

A computing device, for instance, may be configured as a desktop computer, a laptop computer, a mobile device (e.g., assuming a handheld configuration such as a tablet or mobile phone), and so forth. Thus, the computing device may range from full resource devices with substantial memory and processor resources (e.g., personal computers, game consoles) to a low-resource device with limited memory and/or processing resources (e.g., mobile devices). Additionally, although a single computing device is shown, a computing device may be representative of a plurality of different devices, such as multiple servers utilized by a business to perform operations “over the cloud” as shown for the service provider system 102 and the digital analytics system 104 and as further described in FIG. 7.

The client device 106 is illustrated as engaging in user interaction with a service manager module 112 of the service provider system 102. As part of this user interaction, feature data 110 is generated. The feature data 110 describes characteristics of the user interaction in this example, such as demographics of the client device 106 and/or user of the client device 106, network 108, events, locations, and so forth. The service provider system 102, for instance, may be configured to support user interaction with digital content 118. A dataset 114 is then generated (e.g., by the service manager module 112) that describes this user interaction, characteristics of the user interaction, the feature data 110, and so forth, which may be stored in a storage device 116.

Digital content 118 may take a variety of forms and thus user interaction and associated events with the digital content 118 may also take a variety of forms in this example. A user of the client device 106, for instance, may read an article of digital content 118, view a digital video, listen to digital music, view posts and messages on a social network system, subscribe or unsubscribe, purchase an application, and so forth. In another example, the digital content 118 is configured as digital marketing content to cause conversion of a good or service, e.g., by “clicking” an ad, purchase of the good or service, and so forth. Digital marketing content may also take a variety of forms, such as electronic messages, email, banner ads, posts, articles, blogs, and so forth. Accordingly, digital marketing content is typically employed to raise awareness and conversion of the good or service corresponding to the content. In another example, user interaction and thus generation of the dataset 114 may also occur locally on the client device 106.

The dataset 114 is received by the digital analytics system 104, which in the illustrated example employs this data to control output of the digital content 118 to the client device 106. To do so, an analytics manager module 122 generates data describing a predicted action, illustrated as predicted action data 124. The predicted action data 124 is configured to control which items of the digital content 118 are output to the client device 106, e.g., directly via the network 108 or indirectly via the service provider system 102, by the digital content control module 126.

To generate the predicted action data 124, the analytics manager module 122 implements a hybrid deep learning analytics system 128 having a main path 130 and an auxiliary path 132. The hybrid deep learning architecture system 128 provides an automated, learning architecture that overcomes limitations of conventional handcrafted efforts to thus provide an improved feature set that increases accuracy of a model used to generate a prediction of occurrence of an action, e.g., the generate the predicted action data 124.

The hybrid deep learning architecture system 128 solves conventional technical challenges by incorporating a main path 130 that includes modules that implement neural networks to process input data including activity logs and the like, and an auxiliary path 132 that processes profiles (e.g., having static profile features and dynamic profile features). The hybrid deep learning architecture system 128 also includes a connection architecture implemented as another neural network between the main and auxiliary paths 130, 132 respectively, to leverage long term interactions determined from the main path 130 with profile features (e.g., both the static profile features and dynamic profile features) of the auxiliary path 132 to produce predicted intended user actions. This facilitates data utilization to provide multiple historical outcomes for each entity.

The innovative hybrid deep learning architecture system 128 also reduces biased data sampling by, at least in part, utilizing a convolutional neural network system to summarize aggregated user input, such as activity logs, and processing the summarized aggregated user input using a long short term memory (LSTM) neural network system. The long short term memory neural network approach facilitates classification, processing, and predicting time series given time lags of unknown size and duration between events. A time distributed dense network system is then used to process the data produced by the long short term memory neural network, as well as static and dynamic profile data from the auxiliary path 132 to provide more robust and accurate labels which constitute predicted user intended actions that are predicted to happen in a next fixed time window at the end of a LSTM summary time span. The computing device 102 may be coupled to other computing devices via a network and may be implemented by a computing device that may assume a wide variety of configurations.

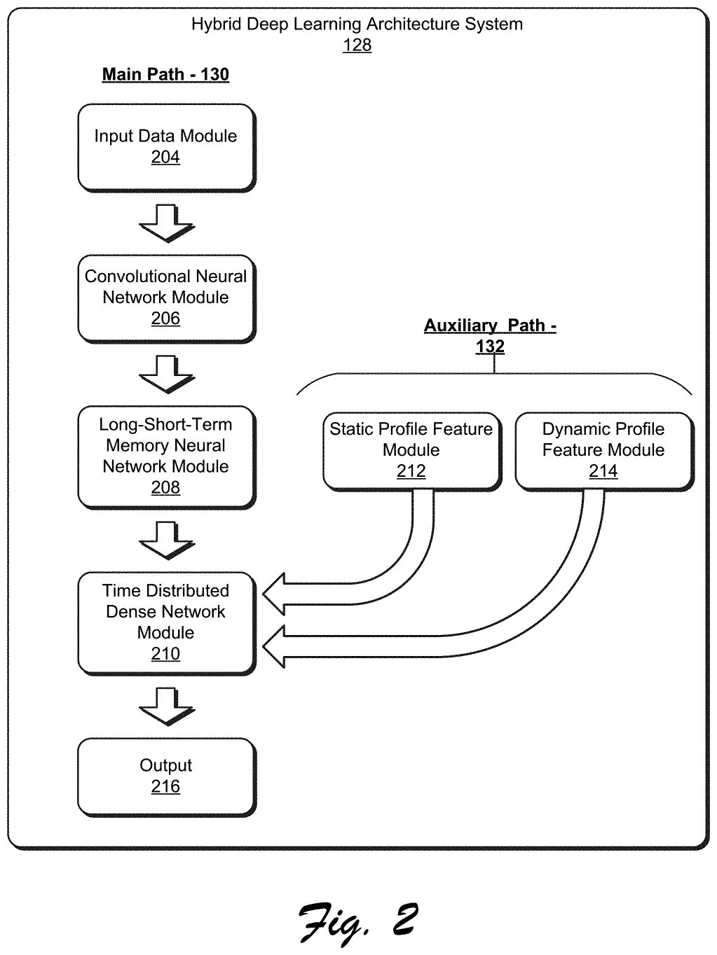

In the illustrated and described example, and as shown in more detail in FIG. 2, the main path 130 of the hybrid deep learning architecture system 138 includes an input data module 204, a first neural network (e.g., implemented by a convolutional neural network module 206) a second neural network (e.g., implemented by a long short-term memory neural network module 208), and a third neural network (e.g., implemented by a time distributed dense network module 210). The auxiliary path 132 includes a static profile feature module 212 and a dynamic profile feature module 214. The static profile feature module 212 and dynamic profile feature module 214 provide input to the time distributed dense network module 210 to produce an output 216 which, in this example, comprises predicted user action labels. The modules that constitute the main path 106 and auxiliary path 108 can be implemented in any suitable hardware, software, firmware, or combination thereof.

The Main Path—130

In the main path 130, the input data module 204 receives user input data which is the summary of user product usage activities over certain granularities of time. The granularities of time can vary. The user usage activities can include, by way of example and not limitation, products launched (e.g., with software programs have been launched), usage of specific features within the products for software companies, or product webpage browser, add-to-cart functionality, product purchases for ecommerce companies, or account activities, credit card usage, online banking logins for banks and financial institutions, or other relevant product or service usages for different companies in various lines of businesses. The summaries can include, by way of example and not limitation, a sum, mean, minimum, max, standard deviation, and other aggregation methods applied to counts, time duration of the user activities, and the like. As noted above, granularities of time can include, by way of example and not limitation, minute, hourly, daily, weekly, monthly, or any reasonable time duration. Thus, the granularities of time associated with user usage summaries can be represented as a time span, which can be organized as a vector.

The input data module 204 processes the input data to divide the input data into blocks which contain user usage summary vectors over many time spans.

Then, each block of input data is passed to a first neural network of the hybrid deep learning architecture system 128. In the illustrated example, the first neural network is implemented by a convolutional neural network module 206. The convolutional neural network module 206 may include one or more convolutional neural networks (CNNs) that can process data as described above and below. In the present example, the convolutional neural network module 206 is utilized to aggregate usage information at different levels via a configurable kernel size. One example of how this can be done is provided below in the section entitled “Implementation Example”.

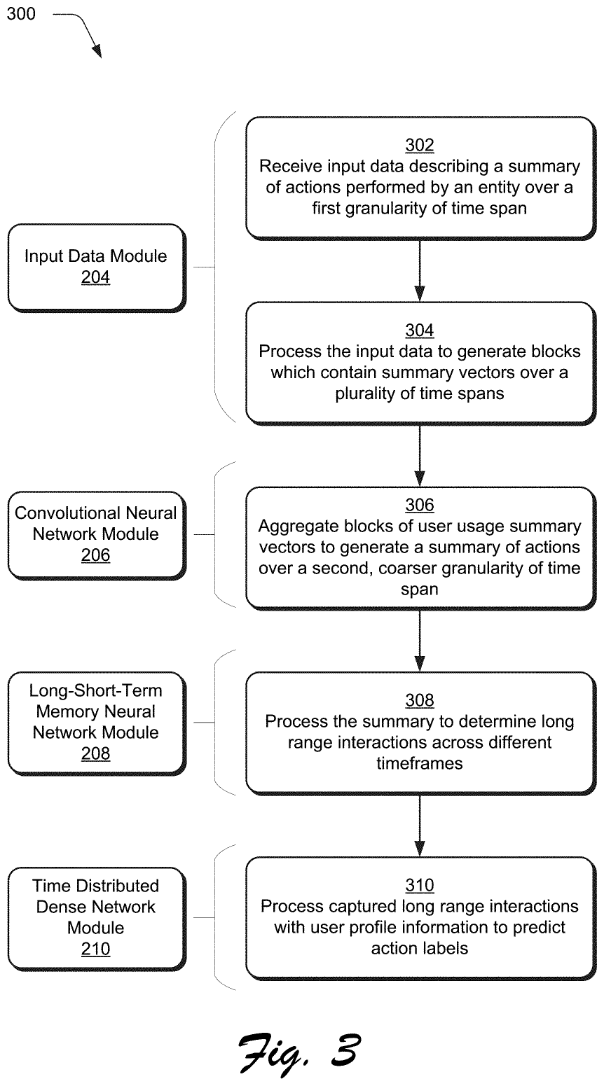

The convolutional neural network module 206 is capable of transforming original summary time steps to coarser granularities of time spans. For example, if original input data received from the input data module 204 is a daily summary, blocks of 7 daily summaries can be passed by the input data module 204 to the convolutional neural network module 206, and processed to have an output of one vector. Effectively, in this example, this achieves a weekly summary. It is to be appreciated and understood that this design is more automatic and incorporates far richer relations than handcrafted aggregation efforts can do; and, the rich relations are learned through training the whole model. With the illustrated and described convolutional neural network module 206, a system may start with a relative finer granularity time span summary, then transit to a coarser granularity time span summary though the CNNs. Hence, this achieves noise reduction and training data size reduction, and enables the model to train faster, without loss of model accuracy. It is to be appreciated and understood that the blocks passed into the convolutional neural network module 206 can be non-overlapping and continuous, or partially overlapped. Further, in one or more implementations, multiple layers of CNNs can be introduced to perform further summary, e.g. the convolutional neural network module 206 may include a first CNN (CNN1) and a second CNN (CNN2) to perform further summaries, as described in more detail in FIG. 3. All these variations in the CNN architecture and block size can be tuned to achieve the best model performance on the validation data. Thus, a dynamic and flexibly-tunable system can be utilized to quickly and efficiently adapt to different data processing environments.

The aggregated output of the convolutional neural network module 206 is provided to a second neural network, which is illustrated as implemented by a long short-term memory (LSTM) neural network module 208. In this particular example, the LSTM is a predicting component of the hybrid deep-learning architecture system 128.

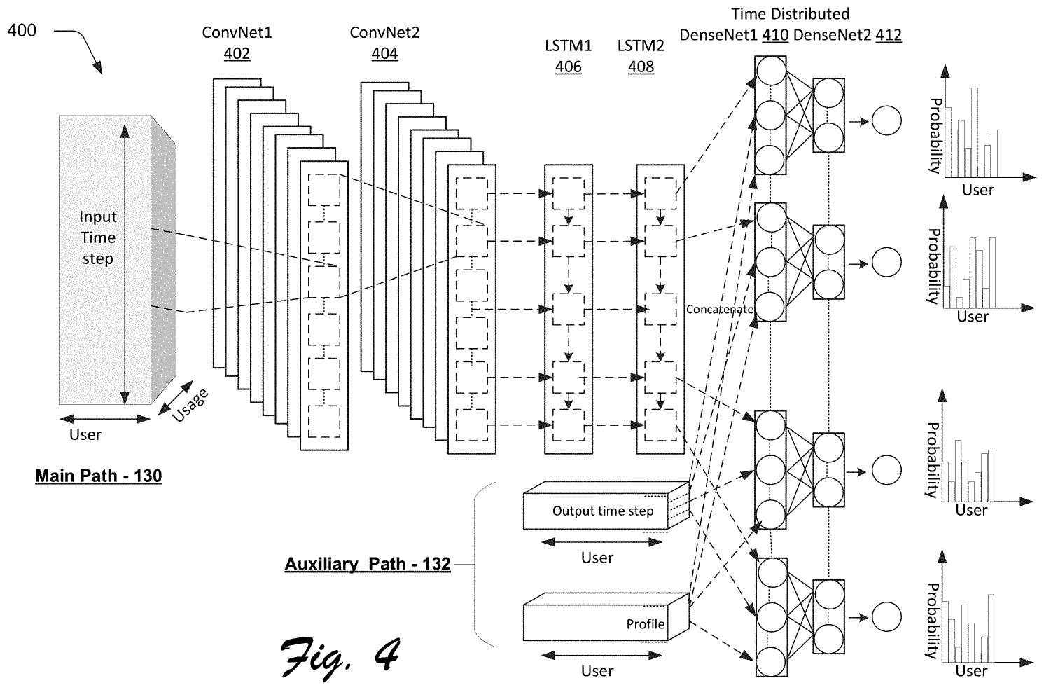

Any number of LSTMs can be used. In at least some implementations, a configuration of two LSTM layers is utilized, as described in more detail in FIG. 4. LSTMs with multiple inputs and outputs are designed in these implementations to capture long-range interactions among aggregated usage across different time frames. Since LSTMs may have an output for every layer, LSTMs can perform model training using action label at multiple time steps simultaneously at the minimum time resolution of the LSTM output. This is to train the LSTM model to learn multiple labels at the same time due to the architecture of LSTM (i.e., outputs at every hidden layer). The training of the model is accomplished, in this implementation, using TensorFlow, an open source Machine Learning framework, which deals with the training and minimizes the loss function in which multiple labels at different LSTM layers contribute to the loss at the same time. Hence, the model learns the multiple labels at the same time.

The output of the long short-term memory neural network module 208 is provided to a third neural network, an illustrated example of which is implemented by a time distributed dense network module 210. The time distributed dense network module 210 also receives a profile from the auxiliary path 108 in the form of one or more of static profile features from static profile feature module 212, or dynamic profile features from dynamic profile feature module 214. The profile is incorporated into the model in order to improve performance as further described in the following section.

The Auxiliary Path—132

In the auxiliary path 132, profiles are taken as inputs to the third neural network of the time distributed dense network module 210 to augment the learning of the hybrid deep learning architecture system 138. In the illustrated and described implementation, profiles can be static, dynamic, or both.

The static profiles are shared across all output time steps after the LSTM output. The dynamic profiles, such as subscription age, are associated with the corresponding output steps for the same entity, e.g., device or user. Specifically, relatively static profiles cover many details including, but not limited to, gender, geographical location, market segments and so forth. Regarding the representation of subscription age, some implementations may conduct both monthly and annual discretization of age (days since subscription) to capture the corresponding two representative subscription types.

Taken together, for each time step, the output status learned from usage in the main path 130 (output from LSTM) and the fused vector of dynamic profiles (like subscription age) and static profiles are concatenated and then provided as input to the third neural network of the time-distributed dense network module 210 which, in this example, are fully connected networks to predict the action label—in this case, output 216.

In the illustrated and described example, label definition is straightforward. Since actions, like conversion or churn, may happen any time in the future, the probability of the actions happening at a specific moment (infinitesimal time interval) approaches zero. Hence, a probability is predicted as to whether the action will happen in the next fixed time window for convenience, i.e. cumulative probability in that window. Thus, in the learning architecture, the label is defined as action happening in the next fixed time window at the end of the LSTM summary time span. This fixed time window can be 1 week, 1 month, 3 months, or any other reasonable time span that fits a particular business requirement. As mentioned previously, action labels can be defined at every fully connected network linking LSTM output with the auxiliary path, which captures the evolution of action status of a single entity. This practice also increases data utilization compared with conventional techniques, since a single entity's historical data is utilized multiple times in training.

Having considered an example operating environment that includes a hybrid deep learning architecture system 128, consider now example procedures in accordance with one or more implementations.

Example Procedures

The following discussion describes techniques that may be implemented utilizing the previously described systems and devices. Aspects of each of the procedures may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to FIGS. 1 and 2 which constitutes but one way of implementing the described functionality.

FIG. 3 depicts a procedure 300 in an example implementation in which a hybrid deep-learning architecture system 128 is be utilized to predict action occurrence. As but one example, the various functional blocks about to be described are associated with the architecture described in FIGS. 1 and 2 for purposes of providing the reader context of but one system that can be utilized to implement the described innovation. It is to be appreciated and understood, however, that architectures other than the specifically described architecture of FIGS. 1 and 2 can be utilized without departing from the spirit and scope of the claimed subject matter.

At block 302, input data is received describing a summary of actions performed by a corresponding entity over a first granularity of time span. This operation can be performed, for example, by input data module 204. The input data can include any suitable type of data that describes occurrence of actions over time by a entity, e.g., device or user. The input data may vary greatly to describe a variety of different entities and actions associated with the entities. The entities, for instance, may describe devices and therefore the actions may refer to operations performed by the devices. In another example, the entities reference users and actions performed by the users, e.g., conversion, signing up of a subscription, and so forth. In addition, time span granularity can vary as well depending on such things as the nature of the entities and actions that are processed by the hybrid deep learning architecture system 128.

At block 304, the input data is processed to generate blocks containing summary vectors over a plurality of time spans. This operation can be performed, for example, by input data module 204. At block 306, the blocks of user usage summary vectors are aggregated to generate a summary of actions over a second, coarser granularity of time span. In one or more implementations, this operation can be performed by a convolutional neural network module 206 which may include one or more CNNs to facilitate aggregation at different levels. Aggregation of blocks can result in daily summaries being aggregated into weekly summaries, weekly summaries being aggregated into monthly summaries, and so on. In some instances, one CNN may aggregate the daily summaries into weekly summaries, and another CNN may aggregate the weekly summaries into monthly summaries.

At block 308, the summary over the second, coarser granularity of time span is processed by a second neural network to determine long-range interactions across different time frames. This operation can be performed by the second neural network as implemented by a long short term memory neural network module 208.

At block 310, the captured long-range interactions are processed by a third neural network with a profile obtained from the auxiliary path to predict action labels. The profile may include one or more of static profile features or dynamic profile features as described above. In one implementation, this operation can be performed by the third neural network as implemented by the time distributed dense network module 210.

Consider now an implementation example that illustrates various advantages of the described innovation over conventional systems.

Implementation Example

To illustrate the above-described hybrid deep-learning architecture based on the multi-path algorithm for action prediction, the following demonstration illustrates a specific application of the innovation to predict customer churn for Adobe products. The model was developed based on historical data of Adobe users of seven products (Photoshop, Illustrator, Lightroom etc.) from Apr. 1, 2014 to May 31, 2017. Churn users (positive examples) and active users (negative examples) were sampled to 1:1 ratio to form the training data with about 660,000 training examples.

In this specific implementation example, the raw input data into the architecture was the daily product usage summary Specifically, the input data used included the daily launch counts and daily total session time of all launches for each of the seven products. In this manner, 14 daily usage summary features are used to form the feature vectors, and 360 of these daily summary feature vectors were created for each user to form the raw input data processed by the input data module 204 in FIG. 2.

The architecture and module associations used in this particular example is represented in FIG. 4 generally at 400. In this particular implementation examples, two ConvNets 402, 404 (ConvNet1 and ConvNet2) are chosen to constitute the convolutional neural network module 206, and two LSTMs 406, 408 (LSTM1 and LSTM2) are chosen to constitute the long short term memory neural network module 208 (FIG. 2). In operation, 360 daily summary feature vectors of length 14 are fed into the ConvNet1 402 (32 kernels with size of 2 and stride of 2) followed by ConvNet2 404 (32 kernels with size of 5 and stride of 5). The resultant 36 output feature vectors of length 32 are then fed into LSTM1 406 with 36 recurrent layers (64 kernels each layer) and 36 output units, which are further followed by LSTM2 408 with 36 recurrent layers (64 kernels each layer) and 12 output units. The respective LSTM outputs and the profile features from auxiliary path 108 are then integrated and fed to two-layer dense neural networks 410, 412 (time distributed dense network module 210) of 40 and 20 nodes to predict churn labels.

The static profile features (static profile feature module 212) in the auxiliary path 108, are composed of geographical location and market segment which are copied and fed to the dense neural networks 410, 412, and the dynamic profile features (dynamic profile feature module 214) like the user subscription age are fed into the dense neural networks 410, 412 at every LSTM with corresponding output values. The churn labels only appear at the final output at a 30-day interval. Churn is defined in this instance as un-subscription or no renewal after subscription expiration in the next 30 days at the end of the feature summary window.

It is noted that the chosen specific variation is only for demonstration purposes considering both simplicity and performance. It is to be appreciated and understood that while the implementation example used a specific number of ConvNets and LSTMs, the techniques and system described herein can be employed using combinations of any number of ConvNets and RNN/LSTMs connected in a similar manner as described above, regardless of any variation in the associated model hyper-parameters, such as number of ConvNets and LSTMs, number of input feature vectors passed to ConvNets, kernel number and size (aggregation granularity) of different layers and final output units.

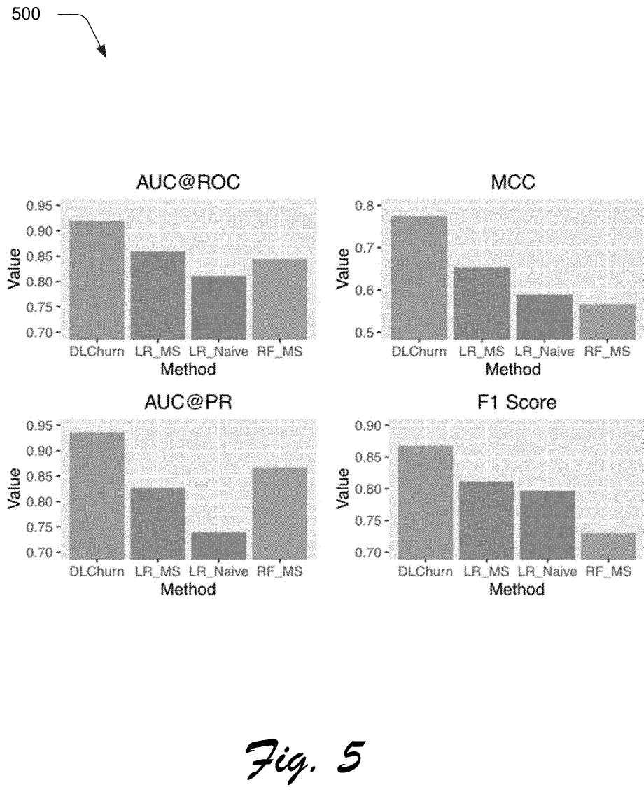

For purposes of evaluation, a comparison was made of the performance of this innovative realization (annotated as “DLChurn” in FIG. 5) with other conventional methods in two scenarios. In the first scenario, we focused on the users who were still active on May 31, 2017. The churn probability in the next month (Jun. 1 to Jun. 30, 2017) of the techniques described herein is compared with different baseline models: naïve logistic regression (LR_Naive), logistic regression with multi-snapshot data (LR_MS), and random forest with multi-snapshot data (RF_MS). The results are reported in FIG. 5 at 500.

Performance comparisons of the techniques described herein against other baselines in terms of metrics Area under the Receiving Operating Curves (AUC@ROC), Area under the Precision-Recall Curves (AUC@PR), Matthews correlation coefficient (MCC) and F1 Score.

These comparisons clearly indicate that the hybrid deep-learning action prediction architecture significantly outperforms other popular conventional methods. In the AUC@ROC, a higher value means that the model is better at distinguishing rank order of positive and negative action. In the AUC@PR, precision is the fraction of true positives out of all the examples that the model predicts is positive (above certain threshold). Recall is the fraction of true positives the model retrieves (above certain threshold) out of all positives. The PR-curve is to plot precision against recall at different model score thresholds. Higher values mean that the precision of the model is higher at different recalls. The Matthews correlation coefficient is used in machine learning as a measure of the quality of binary (two-class) classifications. It takes into account true and false positives and negatives and is generally regarded as a balanced measure which can be used even if the classes are of very different sizes. The F1 score is the harmonic mean of precision and recall. The F1 score is a balance of precision and recall.

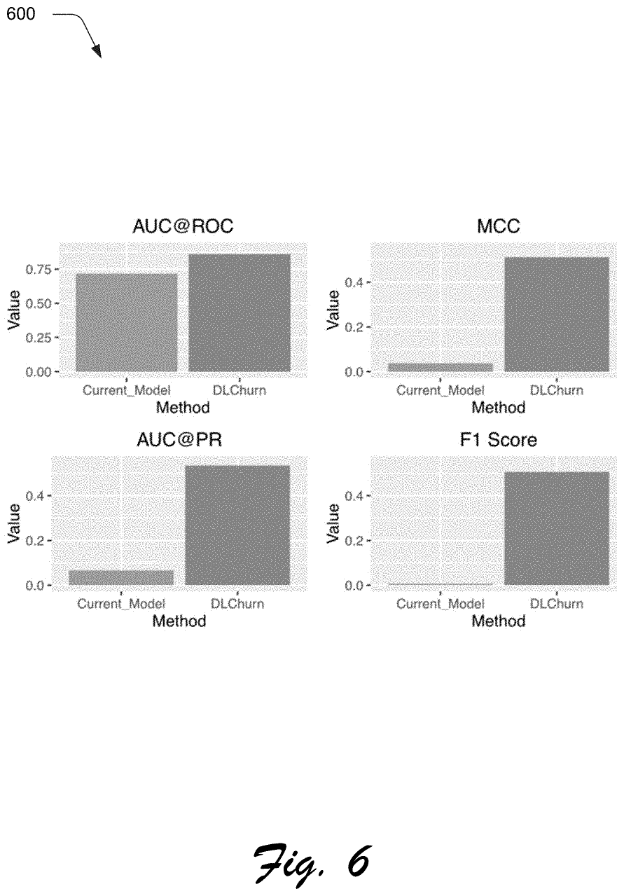

In the second scenario, a comparison is made of current production models on users who are active at the beginning of July, 2017. As the results show in FIG. 6, at 600, the hybrid deep-learning action prediction architecture exhibits improved performance over conventional predictive models.

The illustrated results show performance comparisons of the hybrid deep-learning action prediction architecture against conventional production models in terms of metrics Area under the Receiving Operating Curves (AUC@ROC), Area under the Precision-Recall Curves (AUC@PR), Matthews correlation coefficient (MCC) and F1 Score.

Example System and Device

FIG. 7 illustrates an example system generally at 700 that includes an example computing device 702 that is representative of one or more computing systems and/or devices that may implement the various techniques described herein. This is illustrated through inclusion of the hybrid deep learning architecture system 128. The computing device 702 may be, for example, a server of a service provider, a device associated with a client (e.g., a client device), an on-chip system, and/or any other suitable computing device or computing system.

The example computing device 702 as illustrated includes a processing system 704, one or more computer-readable media 706, and one or more I/O interface 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware elements 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 706 is illustrated as including memory/storage 712. The memory/storage 712 represents memory/storage capacity associated with one or more computer-readable media. The memory/storage component 712 may include volatile media (such as random access memory (RAM)) and/or nonvolatile media (such as read only memory (ROM), Flash memory, optical disks, magnetic disks, and so forth). The memory/storage component 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 502, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of a module that is executable by the computing device 702 as software may be achieved at least partially in hardware, e.g., through use of computer-readable storage media and/or hardware elements 710 of the processing system 704. The instructions and/or functions may be executable/operable by one or more articles of manufacture (for example, one or more computing devices 702 and/or processing systems 704) to implement techniques, modules, and examples described herein.

The techniques described herein may be supported by various configurations of the computing device 702 and are not limited to the specific examples of the techniques described herein. This functionality may also be implemented all or in part through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 may include applications and/or data that can be utilized while computer processing is executed on servers that are remote from the computing device 702. Resources 718 can also include services provided over the Internet and/or through a subscriber network, such as a cellular or Wi-Fi network.

The platform 716 may abstract resources and functions to connect the computing device 702 with other computing devices. The platform 716 may also serve to abstract scaling of resources to provide a corresponding level of scale to encountered demand for the resources 718 that are implemented via the platform 716. Accordingly, in an interconnected device embodiment, implementation of functionality described herein may be distributed throughout the system 700. For example, the functionality, i.e., hybrid deep learning architecture system 104, may be implemented in part on the computing device 702 as well as via the platform 716 that abstracts the functionality of the cloud 714.

### CONCLUSION

The hybrid deep-learning architecture system described above is able to predict user intended actions more quickly and efficiently, which is of great business value to companies. As noted above, the unique model architecture is composed of a main path and an auxiliary path. The main path may contain multiple layers of convolutional neural networks for further aggregation to coarser time spans. The resultant data produced by the convolutional neural networks is passed to multiple layers of LSTMs. The outputs from LSTMs are then combined with the user profile in the auxiliary path to predict user intended action label.

This unique model architecture has several advantages over traditional methods to predict user actions. Specifically, the architecture is capable of automatic feature generation and hence, handcrafted features are no longer needed. Furthermore, the architecture provides multiple outputs for one user at many recurrent layers of LSTMs for increased data utilization.

This formulation also has advantages over LSTM-alone architectures. Specifically, the introduction of the auxiliary path enables inclusion of profile features, which improves model performance. In addition, the introduction of convolutional neural networks transforms original summary time steps to coarser granularities, which reduces both noise and training time. Since convolutional neural networks can have a complex structure and the weights are learned through training, this way of aggregation is more automatic and can preserve more information than manual aggregation. The convolutional neural networks and LSTM hybrid architecture is able to train faster and achieve better performance than LSTM alone architecture.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium action prediction environment, a method implemented by at least one computing device, the method comprising:
generating, by the at least one computing device, a summary of actions over a time span from input data by aggregating blocks of usage summary vectors using a first neural network of a first path of a machine-learning network architecture;
determining, by the at least one computing device, long range interactions across different timeframes from the summary using a second neural network of the first path;
obtaining, by the at least one computing device, a profile from a second path of the machine-learning network architecture, the profile describing characteristics of an entity associated with the actions; and
generating, by the at least one computing device, a prediction of an action by a third neural network based on the obtained profile from the second path and the determined long range interactions across the different timeframes from the first path of the machine-learning network architecture.

2. The method as described in claim 1, wherein the second neural network used for the determining of long range interactions is a long short term memory (LSTM) neural network.

3. The method as described in claim 1, wherein the first neural network used for the generating of the summary of actions is a convolutional neural network.

4. The method as described in claim 1, wherein the third neural network used for the generating of the prediction is a time-distributed dense neural network.

5. The method as described in claim 1, wherein the first neural network includes first and second convolutional neural networks, the second neural network includes first and second long short term memory (LSTM) neural networks, and the third neural network includes first and second time-distributed fully connected dense neural networks.

6. The method as described in claim 1, wherein the entity is a device and the action is an operation performed by the device.

7. The method as described in claim 1, wherein the entity is a user and the actions are performed by the user.

8. The method as described in claim 1, wherein the profile is a static profile that is shared across each of the different timeframes.

9. The method as described in claim 1, wherein the profile is a dynamic profile that is shared with a corresponding time of the different timeframes.

10. The method as described in claim 1, further comprising generating, by the at least one computing device, the blocks that contain usage summary vectors over a plurality of time spans based on input data describing the actions over time span having a first granularity and wherein the generating of the summary has a second granularity that is coarser than the first granularity.

11. In a digital medium action prediction environment, a machine-learning architecture system for predicting intended actions comprising:
a first neural network implemented by at least one computing device to generate a summary of actions over a time span from input data by aggregating blocks of usage summary vectors;
a second neural network implemented by the at least one computing device to determine long range interactions across different timeframes from the summary;
a profile feature module implemented by the at least one computing device to obtain a profile describing characteristics of an entity associated with the actions; and
a third neural network implemented by the at least one computing device to generate a prediction of an action based on the profile from the profile feature module and the determined long range interactions across the different timeframes from the second neural network.

12. The system as described in claim 11, wherein the first and second neural networks form a first path in the machine-learning architecture system and the profile feature module forms a second path in the machine-learning architecture system, the first and second paths joined at the third neural network.

13. The system as described in claim 11, wherein the first neural network is a convolutional neural network.

14. The system as described in claim 11, wherein the second neural network is a long short term memory (LSTM) neural network.

15. The system as described in claim 11, wherein the third neural network is a time-distributed dense neural network.

16. The system as described in claim 11, wherein the first neural network includes first and second convolutional neural networks, the second neural network includes first and second long short term memory (LSTM) neural networks, and the third neural network includes first and second time-distributed fully connected dense neural networks.

17. The system as described in claim 11, wherein the entity is a device and the action is an operation performed by the device.

18. The system as described in claim 11, wherein the entity is a user and the actions are performed by the user.

19. The system as described in claim 11, further comprising an input data module implemented by the at least one computing device to generate the blocks that contain usage summary vectors over a plurality of time spans based on input data describing the actions over time span having a first granularity and wherein the summary has a second granularity that is coarser than the first granularity.

20. In a digital medium action prediction environment, a machine-learning architecture system for predicting intended actions comprising:
means for generating a summary of actions over a time span from input data by aggregating blocks of usage summary vectors;
means for determining long range interactions across different timeframes from the summary;
means for obtaining a profile describing characteristics of an entity associated with the actions; and
means for generating a prediction of an action based on the profile and the determined long range interactions across the different timeframes.
